(19) United States
(12) Patent Application Publication
(10) Pub. No.: US 2024/0030486 A1
(43) Pub. Date: Jan. 25, 2024

(54) METHOD FOR PRODUCING SULFIDE SOLID ELECTROLYTE

(71) Applicant: IDEMITSU KOSAN CO.,LTD., Tokyo (JP)

(72) Inventors: TARO YAMAKI, Chiba-shi (JP); Yoshikatsu SEINO, Sodegaura-shi (JP); Shota TOTSUKA, Sodegaura-shi (JP); Manabu TANAKA, Sagamihara-shi (JP); Hironari KIMPARA, Tokyo (JP)

(73) Assignee: IDEMITSU KOSAN CO.,LTD., Tokyo (JP)

(21) Appl. No.: 18/202,747

(22) Filed: May 26, 2023

(30) Foreign Application Priority Data
May 31, 2022 (JP) 2022-088944
May 19, 2023 (JP) 2023-082923

(51) Int. Cl. H01M 10/0562; C01B 25/14

(52) U.S. Cl. CPC H01M 10/0562; C01B 25/14; H01M 2300/008; C01P 2004/03; C01P 2006/40; C01P 2004/61

(57) ABSTRACT

Provided is a method for producing a sulfide solid electrolyte having excellent productivity and having a particularly small particle size, including mixing a raw material inclusion containing a lithium atom, a sulfur atom, a phosphorus atom, and a halogen atom to obtain an electrolyte precursor, and heating the electrolyte precursor in the presence of a solvent and a dispersant having 8 or more carbon atoms in a molecule thereof in a sealed pressure resistant vessel.

### TECHNICAL FIELD

The present invention relates to a method for producing a sulfide solid electrolyte.

### BACKGROUND ART

With rapid spread of information-related instruments, communication instruments, and so on, such as personal computers, video cameras, and mobile phones, in recent years, development of batteries that are utilized as a power source therefor is considered to be important. Heretofore, in batteries to be used for such an application, an electrolytic solution containing a flammable organic solvent has been used. However, development of batteries having a solid electrolyte layer in place of an electrolytic solution is being made in view of the fact that by making the battery fully solid, simplification of a safety unit may be realized without using a flammable organic solvent within the battery, and the battery is excellent in manufacturing costs and productivity.

As a method for producing a solid electrolyte used in a solid electrolyte layer, a method using an autoclave has been known. For example, PTL 1 discloses a method of calcining a raw material mixture in an autoclave, then heating the mixture at a high temperature in an electric furnace to obtain an argyrodite type solid electrolyte, further adding a surfactant and a solvent, stirring, and then removing the solvent. Further, PTL 2 discloses a method of obtaining an argyrodite type solid electrolyte by heating a raw material mixture in an autoclave in the presence of a solvent having a high boiling point.

### CITATION LIST

### Patent Literature

PTL 1: WO 2021/029315 A
PTL 2: WO 2021/054412 A

### SUMMARY OF INVENTION

### Technical Problem

In the method described in PTL 1, a surfactant and the like are added and stirred after once producing an argyrodite-type solid electrolyte for the purpose of water-resistant coating. Further, in the method described in PTL 2, although a complexing agent is used, the electrolyte precursor is not fired in the presence of a surfactant or the like.

In these conventional production methods including a firing step, particles grow large, and thus it has been difficult to obtain a fine solid electrolyte suitable for a solid electrolyte layer having a particle size of submicron order, for example. When the particles grow large, further atomization treatment is required, which lowers the production efficiency. In addition, it is difficult to heat the complexing agent or solvent having a low boiling point used in the previous step at a high temperature, and the impurities generated in the previous step may cause particles to grow, so it was necessary to remove them once.

The present invention has been made in view of the situation as above, and an object thereof is to provide a method for producing a sulfide solid electrolyte having excellent productivity and having a particularly small particle size.

### Solution to Problem

The method for producing a sulfide solid electrolyte according to the present invention is a method for producing a sulfide solid electrolyte including
mixing a raw material inclusion containing a lithium atom, a sulfur atom, a phosphorus atom, and a halogen atom to obtain an electrolyte precursor, and
heating the electrolyte precursor in the presence of a solvent and a dispersant having 8 or more carbon atoms in a molecule thereof in a sealed pressure resistant vessel.

### Advantageous Effects of Invention

According to the present invention, a method for producing a sulfide solid electrolyte having excellent productivity and having a particularly small particle size can be provided.

### BRIEF DESCRIPTION OF DRAWINGS

FIG. 1 is an SEM (scanning electron microscope) photograph of a solid electrolyte obtained in Example 1.

FIG. 2 is an SEM (scanning electron microscope) photograph of a solid electrolyte obtained in Example 2.

FIG. 3 is an SEM (scanning electron microscope) photograph of a solid electrolyte obtained in Comparative Example 1.

### DESCRIPTION OF EMBODIMENTS

Embodiments of the present invention (hereinafter the embodiment will be sometimes referred to as “present embodiment”) are hereunder described. In the present specification, numerical values of an upper limit and a lower limit according to numerical value ranges of “or more”, “or less”, and “XX to YY” are each a numerical value which can be arbitrarily combined, and numerical values of the section of Examples can also be used as numerical values of an upper limit and a lower limit, respectively. In addition, a provision that is considered preferable can be arbitrarily adopted. That is, one preferable provision may be employed in combination with one or more other preferable provisions. It can be said that a combination of preferable ones is more preferable.

(Findings that the Present Inventors have Obtained to Reach the Present Invention)

The present inventors have assiduously studied for solving the above-mentioned problems and, as a result have found the following matters and have completed the present invention.

As solid electrolytes used in all-solid-state batteries, those having an argyrodite type crystal structure and those having a thioLISICON region II type crystal structure have been known. In a method for producing a solid electrolyte having an argyrodite type crystal structure, PTLs 1 and 2 disclose a production method of preparing an electrolyte precursor by contacting a raw material with a raw material inclusion containing a lithium atom, a sulfur atom, a phosphorus atom, etc. in a state in which a hydrocarbon-based organic solvent is added, producing a solid electrolyte having an argyrodite type crystal structure by firing the electrolyte precursor, and then providing an atomization step of adding a solvent and stirring the mixture.

In view of the fact that fewer production steps are industrially advantageous, the present inventors considered that aggregation of the particulate electrolyte precursor could be suppressed by heating the electrolyte precursor in the presence of a dispersant using an autoclave or the like in a sealed state, and completed the present invention.

### (Sulfide Solid Electrolyte)

First, the terms used in the present specification will be explained.

The “solid electrolyte” as referred to in the present specification means an electrolyte of keeping the solid state at 25° C. in a nitrogen atmosphere. The sulfide solid electrolyte in the present embodiment is a sulfide solid electrolyte at least containing a lithium atom, a sulfur atom, a phosphorus atom, and a halogen atom.

In the “solid electrolyte”, both of an amorphous solid electrolyte and a crystalline solid electrolyte are included.

The crystalline solid electrolyte as referred to in the present specification is a material that is a solid electrolyte in which peaks derived from the solid electrolyte are observed in an X-ray diffraction pattern in the X-ray diffractometry, and the presence or absence of peaks derived from the raw materials of the solid electrolyte does not matter. That is, the crystalline solid electrolyte contains a crystal structure derived from the solid electrolyte, in which a part thereof may be a crystal structure derived from the solid electrolyte, or all of them may be a crystal structure derived from the solid electrolyte. The crystalline solid electrolyte may partially contain an amorphous solid electrolyte in a part thereof so long as it has the X-ray diffraction pattern as mentioned above. In consequence, in the crystalline solid electrolyte, a so-called glass ceramics which is obtained by heating the amorphous solid electrolyte to a crystallization temperature or higher is contained.

The amorphous solid electrolyte as referred to in the present specification is a halo pattern in which other peak than the peaks derived from the materials is not substantially observed in an X-ray diffraction pattern in the X-ray diffractometry, and the presence or absence of peaks derived from the raw materials of the solid electrolyte does not matter.

### (Various Forms of the Present Embodiment)

The method for producing a sulfide solid electrolyte according to a first form of the present embodiment is a method for producing a sulfide solid electrolyte including
mixing a raw material inclusion containing a lithium atom, a sulfur atom, a phosphorus atom, and a halogen atom to obtain an electrolyte precursor, and
heating the electrolyte precursor in the presence of a solvent containing a dispersant having a linear or branched hydrocarbon group having 8 or more carbon atoms in a sealed pressure resistant vessel.

In the method for producing a sulfide solid electrolyte according to the present embodiment, by heating the electrolyte precursor in the presence of a specific dispersant in a sealed pressure resistant vessel, a sulfide solid electrolyte is produced while preventing the particles of the electrolyte precursor from aggregating with each other.

Therefore, the sulfide solid electrolyte obtained by the production method of the present embodiment does not show particle growth due to aggregation, and has a particle size that is small enough to eliminate the need for a subsequent atomization treatment.

As a dispersant that can be used in the production method of the present embodiment, of those generally known as dispersants having a hydrophilic group and a hydrophobic group, it is necessary to use a dispersant having a linear or branched hydrocarbon group having 8 or more carbon atoms from the viewpoint of increasing the inter-particle distance between the electrolyte precursor particles. When only a common hydrocarbon solvent is used, aggregation of the electrolyte precursor particles occurs, and the resulting sulfide solid electrolyte has a large particle size.

The method for producing a sulfide solid electrolyte according to the present embodiment is industrially very useful because a sulfide solid electrolyte with a small particle size can be obtained without the need for subsequent atomization treatment.

The method for producing a sulfide solid electrolyte according to a second form of the present embodiment is a production method in which, in the first form, the dispersant has a boiling point of 170° C. or higher.

The dispersant used in the production method of the present embodiment is exposed to high temperatures when the electrolyte precursor is heated in a sealed pressure resistant vessel, and thus it is preferable to use a dispersant having a high boiling point.

The method for producing a sulfide solid electrolyte according to a third form of the present embodiment is a production method in which, in the first or second form,
the dispersant is one or more selected from an anionic dispersant having a linear or branched hydrocarbon group having 8 to 30 carbon atoms, a cationic dispersant having a linear or branched hydrocarbon group having 8 to 30 carbon atoms, and a nonionic dispersant having a linear or branched hydrocarbon group having 8 to 30 carbon atoms.

Further, the method for producing a sulfide solid electrolyte according to a fourth form of the present embodiment is a production method in which, in any one of the first to third forms,
the dispersant is a sulfonate.

As the dispersant used in the production method of the present embodiment, those generally known as dispersants as described above and having a linear or branched hydrocarbon group having 8 or more carbon atoms can be used. However, specifically, a dispersant selected from the anionic dispersant having a linear or branched hydrocarbon group having 8 to 30 carbon atoms, the cationic dispersant having a linear or branched hydrocarbon group having 8 to 30 carbon atoms, and the nonionic dispersant having a linear or branched hydrocarbon group having 8 to 30 carbon atoms is preferably used, and of the anionic dispersants, a sulfonate is particularly preferably used.

The method for producing a sulfide solid electrolyte according to a fifth form of the present embodiment is a production method in which, in any one of the first to fourth forms,
the temperature when heating the electrolyte precursor is 250° C. or higher and 500° C. or lower.

When obtaining a crystalline sulfide solid electrolyte by the production method of the present embodiment, the heating temperature is preferably within the above range.

The method for producing a sulfide solid electrolyte according to a sixth form of the present embodiment is a production method in which, in any one of the first to fifth forms,
when heating the electrolyte precursor, the pressure resistant vessel has an internal pressure of 0.35 MPa or more and 2.0 MPa or less.

Further, the method for producing a sulfide solid electrolyte according to a seventh form of the present embodiment is a production method in which, in any one of the first to sixth forms,
the pressure resistant vessel is an autoclave apparatus.

In the production method of the present embodiment, the electrolyte precursor can be efficiently heated by setting the pressure condition within the above range when heating the electrolyte precursor in a sealed pressure resistant vessel, or by using an autoclave apparatus as the pressure resistant vessel.

The method for producing a sulfide solid electrolyte according to an eighth form of the present embodiment is a production method in which, in any one of the first to seventh forms,
the raw material inclusion contains at least chlorine as the halogen atom.

As a specific aspect for producing a sulfide solid electrolyte having an argyrodite type crystal structure, it is preferable that the halogen atom as a raw material inclusion contains chlorine.

The method for producing a sulfide solid electrolyte according to a ninth form of the present embodiment is a production method in which, in any one of the first to eighth forms,
the solvent has a boiling point of 190° C. or higher.

Similar to the dispersant described above, the solvent used in the production method of the present embodiment is exposed to high temperatures when the electrolyte precursor is heated in a sealed pressure resistant vessel, and thus it is preferable to use a solvent having a high boiling point.

The method for producing a sulfide solid electrolyte according to a tenth form of the present embodiment is a production method in which, in any one of the first to ninth forms,
the solvent further contains one or more selected from an aromatic hydrocarbon solvent and an ether-based solvent.

As the solvent used in the production method of the present embodiment, it is preferable to use a solvent that has excellent heat resistance and does not adversely affect the quality of the sulfide solid electrolyte. Specifically, an aromatic hydrocarbon solvent and an ether-based solvent are preferably used.

The method for producing a sulfide solid electrolyte according to an eleventh form of the present embodiment is a production method in which, in any one of the first to tenth forms,
when the heating is carried out, the dispersant has an amount of 0.1 to 20% by mass with respect to the amount of the electrolyte precursor.

The amount of the dispersant used in the production method of the present embodiment is preferably within the above range from the viewpoint of reducing the residual amount in the produced sulfide solid electrolyte while ensuring the inter-particle distance of the particulate electrolyte precursor.

The method for producing a sulfide solid electrolyte according to a twelfth form of the present embodiment is a production method in which, in any one of the first to eleventh forms,
when the heating is carried out, the ratio of the amount of the electrolyte precursor to the total amount of the electrolyte precursor and the solvent is 0.50 to 50% by mass.

In the production method of the present embodiment, the amount of the electrolyte precursor is preferably within the above range from the viewpoint of improving productivity while suppressing the aggregation of the electrolyte precursor during heating.

### [Method for Producing Sulfide Solid Electrolyte]

The method for producing a sulfide solid electrolyte of the present embodiment is a method for producing a sulfide solid electrolyte including
mixing a raw material inclusion containing a lithium atom, a sulfur atom, a phosphorus atom, and a halogen atom to obtain an electrolyte precursor, and
heating the electrolyte precursor in the presence of a solvent and a dispersant having 8 or more carbon atoms in a molecule thereof in a sealed pressure resistant vessel.

### [Mixing a Raw Material Inclusion Containing a Lithium Atom, a Sulfur Atom, a Phosphorus Atom, and a Halogen Atom to Obtain an Electrolyte Precursor]

In the method for producing a sulfide solid electrolyte of the present embodiment, an electrolyte precursor is obtained by mixing a raw material inclusion containing a lithium atom, a sulfur atom, a phosphorus atom, and a halogen atom.

### (Raw Material Inclusion)

As the solid electrolyte raw material contained in the raw material inclusion used in the present embodiment, from the viewpoint of obtaining a sulfide solid electrolyte containing a lithium atom, a sulfur atom, a phosphorus atom, and a halogen atom, a raw material containing one kind of atom selected from a lithium atom, a sulfur atom, a phosphorus atom, and a halogen atom is preferably used, and it is only necessary that the raw material inclusion as a whole contains a lithium atom, a sulfur atom, a phosphorus atom, and a halogen atom by combining one or more kinds of raw materials.

Examples of the solid electrolyte raw materials containing a lithium atom, a sulfur atom, and a phosphorus atom include lithium sulfide (Li₂S) and phosphorus sulfide, such as phosphorus trisulfide (P₂S₃) and phosphorus pentasulfide (P₂S₅).

The lithium sulfide is preferably particulate.

The average particle size (D50) of the lithium sulfide particle is preferably 0.1 μm or more and 300 μm or less, more preferably 1 μm or more and 100 μm or less, still more preferably 3 μm or more and 50 μm or less, and particularly preferably 5 μm or more and 30 μm or less. In the present specification, the average particle size (D50) is the particle size at which 50% of the total particle size is reached by accumulating sequentially from the particle having the smallest particle size when drawing a particle size distribution accumulation curve, and the volume distribution refers to the average particle size, which can be measured using, for example, a laser diffraction/scattering particle size distribution analyzer. Further, for other solid raw materials used in the present embodiment, it is preferably one having an average particle size of the same degree as in the aforementioned lithium sulfide particle, namely one having an average particle size falling within the same range as in the aforementioned lithium sulfide particle is preferred.

In addition, as the solid electrolyte raw material, a solid electrolyte raw material containing a halogen atom is used from the viewpoint of improving ionic conductivity.

Typical examples of the raw materials containing a halogen atom include compounds composed of at least two elements selected from the above-mentioned four atoms, that is, a lithium atom, a phosphorus atom, a sulfur atom, and a halogen atom, such as lithium halides, e.g., lithium fluoride, lithium chloride, lithium bromide, and lithium iodide; phosphorus halides, e.g., various phosphorus fluorides (e.g., PF₃ and PF₅), various phosphorus chlorides (e.g., PCl₃, PCIS, and P₂Cl₄), various phosphorus bromides (e.g., PBr₃ and PBr₅), and various phosphorus iodides (e.g., PI₃ and P₂I₄); and thiophosphoryl halides, e.g., thiophosphoryl fluoride (PSF₃), thiophosphoryl chloride (PSCl₃), thiophosphoryl bromide (PSBr₃), thiophosphoryl iodide (PSI₃), thiophosphoryl dichlorofluoride (PSCl₂F), and thiophosphoryl dibromofluoride (PSBr₂F), as well as halogen simple substances, such as fluorine (F₂), chlorine (Cl₂), bromine (Br₂), and iodine (I₂), with chlorine (Cl₂), bromine (Br₂), and iodine (I₂) being preferred.

As materials which may be used as the raw material other than those mentioned above, a raw material containing not only at least one atom selected from the above-mentioned lithium atom, phosphorus atom, sulfur atom, and halogen atom, but also other atom than the foregoing four atoms can be used. More specifically, examples thereof include lithium compounds, such as lithium oxide, lithium hydroxide, and lithium carbonate; alkali metal sulfides, such as sodium sulfide, potassium sulfide, rubidium sulfide, and cesium sulfide; metal sulfides, such as silicon sulfide, germanium sulfide, boron sulfide, gallium sulfide, tin sulfide (e.g., SnS and SnS₂), aluminum sulfide, and zinc sulfide; phosphoric acid compounds, such as sodium phosphate and lithium phosphate; halide compounds of an alkali metal other than lithium, such as sodium halides, e.g., sodium iodide, sodium fluoride, sodium chloride, and sodium bromide; metal halides, such as an aluminum halide, a silicon halide, a germanium halide, an arsenic halide, a selenium halide, a tin halide, an antimony halide, a tellurium halide, and a bismuth halide; and phosphorus oxyhalides, such as phosphorus oxychloride (POCl₃) and phosphorus oxybromide (POBr₃).

More specifically, “mixing a raw material inclusion containing a lithium atom, a sulfur atom, a phosphorus atom, and a halogen atom to obtain an electrolyte precursor” in the method for producing a sulfide solid electrolyte of the present embodiment preferably includes the following steps (i) and (ii).
(i) A mixing step of mixing a raw material inclusion containing a lithium atom, a sulfur atom, and a phosphorus atom to obtain a first precursor having a Li₃PS₄ structure.
(ii) A step of mixing the first precursor obtained in the step (i) with a halogen atom-containing solid electrolyte raw material to obtain an electrolyte precursor.

### (Step (i))

The first precursor obtained in the above step (i) has a Li₃PS₄ structure from the viewpoint of improving ionic conductivity. Further, the first precursor may contain an unreacted solid electrolyte raw material and the like in addition to the Li₃PS₄ structure.

As the raw materials used in the step (i), of those mentioned above, it is preferable to use lithium sulfide (Li₂S) and phosphorus sulfide such as phosphorus trisulfide (P₂S₃) and phosphorus pentasulfide (P₂S₅).

In this case, the blending ratio of lithium sulfide and phosphorus sulfide is not particularly limited as long as it is within a range of ratios capable of forming the Li₃PS₄ structure. From the viewpoint of efficiently forming the PS₄³⁻ structure, in the case of using diphosphorus pentasulfide as the phosphorus sulfide, the ratio of the number of moles of lithium sulfide to the total number of moles of lithium sulfide and diphosphorus pentasulfide is preferably in the range of 60 to 90%, more preferably in the range of 65 to 85%, still more preferably in the range of 70 to 80%, even more preferably in the range of 72 to 78%, and particularly preferably in the range of 73 to 77%.

The step (i) is preferably performed in the presence of a complexing agent.

The complexing agent is a substance capable of forming a complex together with a lithium atom, and is one having such properties of acting with a lithium atom-containing sulfide contained in the above-mentioned solid electrolyte raw material, thereby promoting the formation of a precursor containing a lithium atom, a sulfur atom, and a phosphorus atom, preferably the formation of a PS₄³⁻ structure. The complex obtained by forming a complex with the above lithium atom is a complex containing a lithium atom, a sulfur atom, a phosphorus atom, and a complexing agent, and is preferably one in which amorphous Li₃PS₄ and crystalline Li₃PS₄ of the PS₄³⁻ structure are obtained by removing the complexing agent from the complex (also simply referred to as “decomplexation”).

Not specifically limited, the complexing agent usable here may be any one having the above-mentioned properties. In particular, a compound containing an atom having a high affinity with a lithium atom, for example, a hetero atom such as a nitrogen atom, an oxygen atom, and a chlorine atom is preferred, and a compound having a group that contains such a hetero atom is more preferred. This is because a group containing such a hetero atom can form a coordination bond to lithium.

Preferable examples of the hetero atom include a nitrogen atom, an oxygen atom, and a halogen atom such as a chlorine atom.

Specific examples of the complexing agent include ester-based solvents, such as ethyl acetate and butyl acetate; aldehyde-based solvents, such as formaldehyde, acetaldehyde, and dimethylformamide; ketone-based solvents, such as acetone and methyl ethyl ketone; ether-based solvents, such as diethyl ether, diisopropyl ether, dibutyl ether, tetrahydrofuran, dimethoxyethane, cyclopentyl methyl ether, tert-butyl methyl ether, and anisole; halogen element-containing aromatic hydrocarbon solvents, such as trifluoromethylbenzene, nitrobenzene, chlorobenzene, chlorotoluene, and bromobenzene; amine-based solvents, such as tetramethylethylenediamine, tetraethylethylenediamine, tetramethyldiaminopropane, tetraethyldiaminopropane, cyclopropanediamine, tolylenediamine, and tetraethylenepentamine; nitrile-based solvents, such as acetonitrile, methoxyacetonitrile, propionitrile, methoxypropionitrile, and benzonitrile; and solvents containing a carbon atom and a hetero atom, such as dimethyl sulfoxide and carbon disulfide.

Of these, amine-based solvents, ether-based solvents, and nitrile-based solvents are preferred, and ether-based solvents are more preferred. Of the ether-based solvents, diethyl ether, diisopropyl ether, dibutyl ether, and tetrahydrofuran are preferred, and tetrahydrofuran is more preferred. In addition, as the complexing agent, those having properties in which the solid electrolyte raw material does not dissolve or hardly dissolves are preferred, and from this point of view, amine-based solvents and ether-based solvents are also preferred.

In addition to the above complexing agents, various solvents may be used, and examples thereof include an aliphatic hydrocarbon solvent, such as hexane, pentane, 2-ethylhexane, heptane, octane, decane, undecane, dodecane, and tridecane; an alicyclic hydrocarbon solvent, such as cyclohexane and methylcyclohexane; an aromatic hydrocarbon solvent, such as benzene, toluene, xylene, mesitylene, ethylbenzene, and tert-butylbenzene; a paraffinic solvent, such as a normal paraffin-based solvent, which is an oligomer obtained by polymerizing at least one normal paraffin such as normal butene and normal propylene with a polymerization degree of about 3 to 10, and a hydrogenated product thereof, and an isoparaffinic solvent, which is an oligomer obtained by polymerizing at least one of paraffins such as isobutene, normal butene, normal propylene, and isopropylene containing at least isoparaffin with a polymerization degree of about 3 to 10, and a hydrogenated product thereof.

When a solid electrolyte raw material and a complexing agent are mixed in a liquid phase, the amount of the complexing agent used relative to the solid electrolyte raw material is preferably, in terms of the content of the solid electrolyte raw material with respect to the total amount of the solid electrolyte raw material and the complexing agent, 1 to 50% by mass, more preferably 2 to 30% by mass, still more preferably 3 to 20% by mass, and even more preferably 5 to 15% by mass.

The precursor containing the Li₃PS₄ structure (Li₃PS₄ structure, etc.) can be synthesized by mixing the solid electrolyte raw material and the complexing agent, but can also be synthesized by pulverization, kneading, or a combination thereof. Treatments such as mixing, pulverization, and kneading are events that can occur simultaneously, and therefore may not be clearly distinguished in some cases. This is because when the solid and powdery raw materials exemplified as the raw materials that can be contained in the solid electrolyte raw material are mixed, kneading may occur; at the same time, the solid electrolyte raw materials may collide with each other and may be pulverized or kneaded; and the pulverization itself may also serve as mixing or kneading. Synthesis of the precursor in the mixing step can be said to be carried out, for example, by repeatedly bringing the raw materials into contact with each other by applying force such as rotation and vibration to various raw materials contained in the solid electrolyte raw material, and as long as the contact includes at least the treatment by mixing, any other treatment, such as pulverization and kneading, may be accompanied.

In the present embodiment, treatment of mixing, pulverization, kneading, or a combination thereof can be performed, for example, by a mechanical stirring and mixing machine equipped with an impeller in a tank thereof.

Examples of the mechanical stirring and mixing machine include a high-speed stirring mixer, and a double-arm mixer. A high-speed stirring mixer is preferably used from the viewpoint of promoting reactions by more uniform contact of the various raw materials contained in the raw material inclusion and obtaining a higher ionic conductivity. In addition, examples of the high-speed stirring mixer include a vertical axis rotating type mixer and a lateral axis rotating type mixer, and mixers of any of these types may be used.

Examples of the shape of the impeller which is used in the mechanical stirring mixer include a blade type, an arm type, a ribbon type, a multistage blade type, a double arm type, a shovel type, a twin-shaft blade type, a flat blade type, and a C-shaped blade type. From the viewpoint of promoting reactions by more uniform contact of the various raw materials contained in the raw material inclusion and obtaining a higher ionic conductivity, a shovel type, a flat blade type, a C-shaped blade type impeller or the like is preferred.

In addition, the above treatment can also be performed using, for example, a medium-type pulverizer.

Medium-type pulverizers are roughly divided into container-driven pulverizers and medium agitating pulverizers. Examples of the container-driven pulverizer include a stirring tank, a pulverizing tank, and a combination of these, such as a ball mill and a bead mill. As a ball mill or a bead mill, any of various types such as a rotary type, a rolling type, a vibrating type, and a planetary type can be employed.

Examples of the medium agitating pulverizers include various kinds of pulverizers, for example, impact pulverizers, such as cutter mills, hammer mills, and pin mills; tower pulverizers, such as tower mills; stirring tank pulverizers, such as attritors, aquamizers, and sand grinders; circulation tank type pulverizers, such as Visco mills and pearl mills; circulation tube type pulverizers; annular type pulverizers, such as coball mills; and continuous dynamic type pulverizers.

The treatment can also be carried out, for example, with a single-screw or multi-screw kneader.

In the step (i), from the viewpoint of more efficiently synthesizing a precursor containing a Li₃PS₄ structure (such as a Li₃PS₄ structure), especially a complex containing a lithium element, a sulfur element, a phosphorus element and the complexing agent, it is preferable to employ a treatment using a mechanical stirring and mixing machine.

The temperature for synthesizing the complex in the step (i) is not particularly limited, but can be adjusted within the range of 20 to 100° C., for example. Although the temperature may be about room temperature (23° C.), heating may be carried out in order to advance the synthesis reaction in a short time, and a high temperature is preferable as long as it is a non-drying condition such as reflux. For example, the temperature may be 50 to 90° C., and more preferably about 80° C.

In addition, the synthesis time may be about 0.5 to 100 hours, preferably 1 to 90 hours, and more preferably 3 to 75 hours in consideration of production efficiency.

What is obtained by the above synthesis is a first precursor containing a lithium atom, a sulfur atom, and a phosphorus atom, more specifically one containing a complex formed from a lithium atom, a sulfur atom, a phosphorus atom, and the complexing agent.

### (Drying Step)

The production method of the present embodiment may have a drying step in order to remove the complexing agent and solvent from the obtained slurry when using the complexing agent and solvent in the step (i). In the above step (i), when a slurry containing a complex from which amorphous and crystalline Li₃PS₄ are obtained as described above is obtained, by drying in the drying step, the complexing agent and the solvent can be removed from the slurry to obtain complex crystals.

By removing the complexing agent and the solvent, impurities can be reduced and an improvement in ionic conductivity can be expected. On the other hand, when the above step (i) is carried out in a liquid phase, a slurry containing the first precursor is obtained. Drying these slurries may facilitate the formation of aggregates, and when the aggregates are subjected to heating that is employed as necessary, which will be described later, a larger sintered body will be formed. As a result, a solid electrolyte with a small particle size may not be obtained. In such a case, it is preferable to carry out a pulverization treatment.

Drying can be performed at a temperature according to the kind of the remaining complexing agent and solvent on the precursor accompanied by the complexing agent and solvent. For example, the drying can be performed at a temperature of a boiling point of the remaining complexing agent or solvent or higher. The drying temperature may be, for example, typically 5 to 100° C., preferably 10 to 90° C., and more preferably 20 to 85° C. In addition, drying can be performed under reduced pressure (under vacuum) using a vacuum pump or the like.

Although the drying time is not particularly limited, it is preferably 1 minute or longer, more preferably 10 minutes or longer, still more preferably 30 minutes or longer, and even more preferably 1 hour or longer. Although the upper limit of the drying time is not particularly limited, it is preferably 24 hours or less, more preferably 12 hours or less, still more preferably 6 hours or less, and even more preferably 3 hours or less.

The drying may be performed on the first precursor accompanied by the complexing agent and solvent by solid-liquid separation by means of filtration with a glass filter or the like, or solid-liquid separation through decantation, or solid-liquid separation with a centrifuge or the like. In the present embodiment, after performing the solid-liquid separation, the drying may be performed under the aforementioned temperature condition.

Specifically, for the solid-liquid separation, decantation in which the first precursor accompanied by the complexing agent and solvent is transferred into a container, and after the first precursor is precipitated, the solvent as a supernatant is removed, or filtration with a glass filter having a pore size of, for example, about 10 to 200 and preferably 20 to 150 is easy.

### (Heating Step)

The production method of the present embodiment preferably has a heating step of heating the first precursor obtained in the step (i) and further heating the first precursor that has undergone the drying step, separately from step (iii), which will be described later.

Specifically, after removing the complexing agent and solvent from the slurry through the above step (i) and the drying step, the crystalline Li₃PS₄ can also be obtained by heating while adjusting the heating temperature.

Generally, when a solid electrolyte is heated, the particle size of the solid electrolyte increases, causing burning and thickening. In the present embodiment, the particle size of the resulting solid electrolyte can be made smaller by generating the first precursor before step (ii), which will be described later. Therefore, it becomes possible to reduce the particle size and improve the ionic conductivity at the same time.

The heating temperature in the heating step is not particularly limited as long as the first precursor having the Li₃PS₄ structure can be obtained; however, the heating temperature is preferably 140° C. or higher, more preferably 145° C. or higher, still more preferably 150° C. or higher, and even more preferably 170° C. or higher. Although the upper limit is not particularly limited, it is preferably 300° C. or lower, more preferably 275° C. or lower, still more preferably 225° C. or lower, and even more preferably 200° C. or lower. Within the above temperature range, the first precursor having the Li₃PS₄ structure can be produced more efficiently, and mainly crystalline Li₃PS₄ can be obtained.

In the case of mainly obtaining amorphous Li₃PS₄, the upper limit may be 150° C. or lower, preferably 140° C. or lower, and more preferably 135° C. or lower, and although the lower limit is not particularly limited, it may be about 100° C. or higher, preferably 105° C. or higher.

Although the treatment time of the heating step is not particularly limited as long as the first precursor having the Li₃PS₄ structure can be obtained, for example, it is preferably 10 minutes or more, more preferably 30 minutes or more, still more preferably 1 hour or more, and yet still more preferably 4 hours or more. In addition, although the upper limit of the heating time is not particularly restricted, it is preferably 24 hours or less, more preferably 18 hours or less, still more preferably 12 hours or less, and yet still more preferably 10 hours or less.

The heating step may be performed in an inert gas atmosphere (for example, a nitrogen atmosphere and an argon atmosphere) or in a reduced pressure atmosphere (especially, in vacuo). This is because deterioration (for example, oxidation) of the precursor obtained by the above synthesis and mixing can be prevented from occurring.

Further, although a method for heating is not particularly limited, for example, a method of using a hot plate, an autoclave, a vacuum heating device, an argon gas atmosphere furnace, or a firing furnace can be adopted. In addition, industrially, a lateral dryer or a lateral vibration fluid dryer provided with a heating means and a feed mechanism, or the like may be selected according to the heating treatment amount.

Typical examples of the first precursor having the Li₃PS₄ structure obtained in this manner include a complex that can be de-complexed to obtain the amorphous and crystalline Li₃PS₄, amorphous Li₃PS₄, and crystalline Li₃PS₄(β-Li₃PS₄). The first precursor having the Li₃PS₄ structure may contain a single kind of these PS₄³⁻ structures, or may contain a mixture of multiple kinds thereof.

In the present embodiment, a solid electrolyte having a small particle size and high ionic conductivity can be obtained by once forming the Li₃PS₄ structure and subjecting the structure to subsequent steps.

The Li₃PS₄ structure contained in the first precursor thus obtained can be observed by solid-state ³¹P-NMR measurement, and a peak attributed to the PS₄³⁻ structure appears. From the viewpoint of ionic conductivity, the crystal structure composed of a phosphorus atom and a sulfur atom preferably does not include structures other than the PS₄³⁻ structure, for example, crystal structures such as a P₂S₇⁴⁻ structure and a P₂S₆⁴⁻ structure (PₓS_{y}^{a-} structure). According to the synthesis method described above, a precursor containing such a PS₄³⁻ structure can be easily obtained.

(Step (ii))

Step (ii) is a step of mixing the first precursor obtained in the step (i) with a solid electrolyte raw material containing a halogen atom to obtain an electrolyte precursor.

Specific examples of the solid electrolyte raw material containing a halogen atom preferably include lithium halides, such as lithium fluoride, lithium chloride, lithium bromide, and lithium iodide, and halogen simple substances, such as fluorine (F₂), chlorine (Cl₂), bromine (Br₂), and iodine (I₂).

Of the above lithium halides, lithium chloride, lithium bromide, and lithium iodide are preferred, and lithium chloride and lithium bromide are more preferred. Of the halogen simple substances, chlorine (Cl₂), bromine (Br₂), and iodine (I₂) are preferred, and chlorine (Cl₂) and bromine (Br₂) are more preferred.

As a combination of solid electrolyte raw materials containing halogen atoms, a combination of lithium chloride and lithium bromide and a combination of chlorine (Cl₂) and bromine (Br₂) are preferable.

In the production method of the present embodiment, the solid electrolyte raw material containing a halogen atom may be added together with other solid electrolyte raw materials in the above step (i). However, from the viewpoint of more reliably forming the Li₃PS₄ structure, improving the ionic conductivity, and more reliably reducing the particle size, it is preferable to blend after the step (i).

The blending ratio of various solid electrolyte raw materials used for the solid electrolyte raw material in the present embodiment may be appropriately determined according to the desired crystal structure. As one example thereof, the blending ratio of various raw materials in a crystalline solid electrolyte having an argyrodite type crystal structure, which is one of the preferred crystalline solid electrolytes obtained by the production method of the present embodiment, will be described below. The argyrodite type crystal structure will be described later.

For example, when the crystalline Li₃PS₄ (β-Li₃PS₄) obtained in the step (i) is blended with lithium sulfide and lithium halide, the molar ratio of these raw materials (Li₃PS₄:Li₂S:lithium halide) is preferably 15 to 55:3 to 25:20 to 80, more preferably 20 to 45:5 to 20:30 to 70, still more preferably 25 to 40:8 to 18:40 to 60, and yet still more preferably 30 to 35:10 to 15:50 to 55.

Further, when lithium chloride and lithium bromide are used together as lithium halide, the ratio of the number of moles of lithium bromide to the total number of moles of lithium chloride and lithium bromide is preferably 1 to 70%, more preferably 10 to 60%, still more preferably 20 to 50%, and even more preferably 30 to 40%.

### (Pulverization Step)

The production method of the present embodiment preferably includes a pulverization step of pulverizing the electrolyte precursor obtained in the step (ii). By heating the pulverized material pulverized in the present pulverization step in step (iii) to be described later, a crystalline solid electrolyte can be easily obtained even at a lower heating temperature. Further, by performing the present pulverization step, a solid electrolyte having a small particle size and high ionic conductivity can be efficiently obtained.

Specific pulverization method in the pulverization step is not particularly limited; however, from the viewpoint of more efficient pulverization, mechanical milling is preferable because it makes it easier to obtain a solid electrolyte with high ionic conductivity.

Mechanical milling is a process using a medium-type pulverizer exemplified as a method of synthesizing the first precursor in the step (i) above. Medium-type pulverizers are roughly divided into container-driven pulverizers and medium agitating pulverizers, and a container-driven pulverizer such as a ball mill or a bead mill is preferable. Examples of the types of a ball mill or a bead mill include various types such as a rotary type, a rolling type, a vibrating type, and a planetary type, and any of these types can be employed.

The pulverization step is preferably carried out in a liquid phase. Pulverizing in the liquid phase may facilitate pulverization. Therefore, in the production method of the present embodiment, the pulverization step may be performed without removing the complexing agent and the solvent used in the step (i) as they are, or, after the step (i) is completed, a new solvent may be added and pulverization may be carried out in the liquid phase after the complexing agent and the solvent are removed.

As the solvent used in the pulverization step, for example, those exemplified as the complexing agent and solvent that can be used in the synthesis of the first precursor in the step (i) can be used. Preferred solvents are aromatic hydrocarbon solvents, ether-based solvents and nitrile-based solvents, aromatic hydrocarbon solvents and nitrile-based solvents are more preferred, toluene, xylene, ethylbenzene, tert-butylbenzene and isobutyronitrile are still more preferred, and toluene and isobutyronitrile are even more preferred.

In addition, the amount of the solvent used relative to the solid electrolyte raw material in this case is the same as the amount of the complexing agent used in the above step (i).

The average particle size (D50) of the pulverized material obtained in the present pulverization step is preferably 0.01 μm or more and 100 μm or less, more preferably 0.03 μm or more and 50 μm or less, still more preferably 0.05 μm or more and 10 μm or less, and even more preferably 0.1 μm or more and 3 μm or less. When the average particle size of the pulverized material is within the above range, a desired crystalline solid electrolyte can be easily obtained even if the heating temperature is lowered in step (iii). Further, the progress of grain growth is suppressed and the particle size can be kept small. As a result, a crystalline solid electrolyte with a small particle size can be obtained more efficiently.

In the present embodiment, the average particle size of the pulverized material can be within the above range by adjusting the conditions of the pulverization process. For example, in the pulverization process, when adopting mechanical milling processing using a medium-type pulverizer, the particle size of the pulverized material can be adjusted by the particle size, shape, use amount of zirconia balls, zirconia beads, etc. used in the pulverizer, operating conditions of the pulverizer (rotation speed, etc.), and the amount of solvent used for the precursor, etc.

### [Heating the Electrolyte Precursor in the Presence of a Solvent and a Dispersant Having 8 or More Carbon Atoms in a Molecule Thereof in a Sealed Pressure Resistant Vessel]

More specifically, in the method for producing a sulfide solid electrolyte of the present embodiment, the above-mentioned “heating the electrolyte precursor in the presence of a solvent and a dispersant having 8 or more carbon atoms in a molecule thereof in a sealed pressure resistant vessel” preferably includes the following step (iii).

(iii) A step of heating the electrolyte precursor obtained in the step (ii) in the presence of a solvent containing a dispersant having a linear or branched hydrocarbon group having 8 or more carbon atoms in a sealed pressure resistant vessel.
(Step (iii))

The method for producing a crystalline solid electrolyte of the present embodiment preferably includes a step of heating the electrolyte precursor obtained in the step (ii) in the presence of a solvent containing a dispersant having a linear or branched hydrocarbon group having 8 or more carbon atoms in a sealed pressure resistant vessel after, if necessary, the electrolyte precursor is pulverized by the pulverization step. As described above, the electrolyte precursor is preferably a precursor containing a Li₃PS₄ structure. Also, as described above, the electrolyte precursor is preferably a pulverized material that has undergone the above pulverization step.

In the production method of the present embodiment, through the step (iii), the Li₃PS₄ structure contained in the electrolyte precursor, preferably the electrolyte precursor containing the Li₃PS₄ structure, reacts with a raw material containing a halogen element, whereby the halogen element is incorporated into the Li₃PS₄ structure, and further by crystallization, a crystalline solid electrolyte containing a lithium element, a sulfur element, a phosphorus element and a halogen element is obtained.

By heating in the step (iii), the diffusion distance of each element in the particles is shortened, making it easier to obtain the desired crystalline solid electrolyte. In the production method of the present embodiment, by adopting the present step of heating using a pressure resistant vessel in the presence of the solvent containing the dispersant to obtain a solid electrolyte, the dispersant can promote the formation of the solid electrolyte while maintaining the inter-particle distance between the electrolyte precursor particles, and thus it is possible to suppress an increase in particle size.

The solvent used in the step (iii) is required to contain a dispersant having a linear or branched hydrocarbon group having 8 or more carbon atoms as described above.

As the dispersant, of those generally known as a dispersant and has a hydrophilic group and a hydrophobic group, it is necessary to use a dispersant having a linear or branched hydrocarbon group having 8 or more carbon atoms from the viewpoint of maintaining a relatively wide inter-particle distance between the electrolyte precursor particles, and from the viewpoint that it is necessary to use a dispersant having a relatively high boiling point in order to heat the electrolyte precursor in a sealed pressure resistant vessel. Moreover, a dispersant having a linear or branched hydrocarbon group having 30 or less carbon atoms is preferable, a dispersant having a linear or branched hydrocarbon group having 8 to 30 carbon atoms is more preferable, and a dispersant having a linear or branched hydrocarbon group having 8 to 24 carbon atoms is even more preferable, from the viewpoint that in order to obtain a sulfide solid electrolyte with high conductivity, it is preferable to remove impurities as much as possible, and thus the dispersant is preferably one that is easy to remove after heating, and from the viewpoint that by ensuring solubility with a certain number of carbon atoms or less, the dispersant is less likely to precipitate and the effect of dispersing the electrolyte precursor is enhanced.

In addition, the number of carbon atoms in the entire molecule of the dispersant is preferably 8 to 40, more preferably 10 to 32, and even more preferably 12 to 24.

As the dispersant, it is preferable to use one or more selected from an anionic dispersant, a cationic dispersant and a nonionic dispersant.

Specific examples of the anionic dispersant include carboxylates, sulfonates, sulfate ester salts, and phosphate ester salts. Here, when a sulfonate is used as a dispersant, lithium ions, which are cations contained in the sulfide solid electrolyte, and sulfonate ions, which are anions, are likely to interact with each other, particularly. This is preferable because the dispersant is adsorbed on the surface of the sulfide solid electrolyte particles, and its steric hindrance improves the dispersibility. Furthermore, an alkylbenzenesulfonate, such as sodium dodecylbenzenesulfonate, is particularly preferably used as the dispersant. For the same reason as described above, an alkyl group in the alkylbenzenesulfonate is preferably a linear or branched alkyl group having 30 or less carbon atoms, more preferably a linear or branched alkyl group having 8 to 30 carbon atoms, and still more preferably a linear or branched alkyl group having 8 to 24 carbon atoms.

Specific examples of the cationic dispersant include amine salts and ammonium salts.

Specific examples of the nonionic dispersant include esters, ethers, amides, and amines, and aliphatic amines such as oleylamine are particularly preferably used.

The dispersant preferably has a boiling point of 170° C. or higher, more preferably 250° C. or higher, and even more preferably 300° C. or higher.

The amount of the dispersant relative to the amount of the electrolyte precursor during the heating is preferably 0.1 to 20% by mass, more preferably 0.5 to 15% by mass, and still more preferably 1.0 to 10% by mass, from the viewpoint of reducing the residue in the produced sulfide solid electrolyte while ensuring the inter-particle distance of the particulate electrolyte precursor.

When a pulverization step is provided after producing a crystalline solid electrolyte having a desired crystal structure in the above step (iii), the crystal structure may be destroyed, resulting in a decrease in ionic conductivity. From this point of view, it is preferable that the production method of the present embodiment does not include a step of pulverizing after the present step (iii).

The method of heating the electrolyte precursor obtained in the step (ii), preferably the pulverized material obtained in the pulverization step, is not particularly limited as long as it is a method carried out in a sealed pressure resistant vessel. Any method can be adopted, and examples thereof include a method using a pressure resistant vessel such as an autoclave. Of these, an autoclave is preferable from the viewpoint of suppressing an increase in particle size in the step (iii).

In the production method of the present embodiment, the electrolyte precursor is heated in a sealed pressure resistant vessel, and thus the pressure inside the pressure resistant vessel rises and the solid electrolyte can be efficiently produced. Here, even if the pressure resistant vessel is provided with a safety valve, it can be said that the electrolyte precursor is sealed inside the pressure resistant vessel under normal heating conditions.

The heating temperature in the step (iii) may be appropriately adjusted according to the desired solid electrolyte. For example, when producing a solid electrolyte having an argyrodite type crystal structure, the heating temperature is preferably 250° C. or higher and 500° C. or lower, more preferably 280° C. or higher and 470° C. or lower, even more preferably 320° C. or higher and 450° C. or lower, and still more preferably 360° C. or higher and 430° C. or lower.

The heating time in the step (iii) may be appropriately adjusted according to the desired solid electrolyte, and is, for example, preferably 1 minute or more, more preferably 5 minutes or more, even more preferably 10 minutes or more, and still more preferably 15 minutes or more. In addition, the upper limit of the heating time is not particularly limited, but is preferably 10 hours or less, more preferably 5 hours or less, still more preferably 3 hours or less, and even more preferably 2 hours or less.

The internal pressure in the pressure resistant vessel in the step (iii) is preferably 0.35 MPa or more and 2.0 MPa or less, more preferably 0.50 MPa or more and 1.5 MPa or less, and still more preferably 0.80 MPa or more and 1.2 MPa or less.

In addition, the heating can be performed in an inert gas atmosphere (for example, a nitrogen atmosphere and an argon atmosphere) or a reduced pressure atmosphere (especially, in vacuo) to prevent deterioration (for example, oxidation) of the resulting solid electrolyte.

When heating in the step (iii), it is not preferable to dry in advance or to dry at the same time as crystallization. This is because drying may increase the average particle size, and in the production method of the present embodiment, it is preferable to avoid drying as much as possible.

Upon heating in the step (iii), the electrolyte precursor accompanied by the complexing agent and solvent obtained in these steps may be heated as it is without removing the complexing agent and solvent used in the steps (i) and (ii), or the complexing agent and solvent accompanying the electrolyte precursor may be replaced with a high boiling point solvent in advance. However, the solvent replacement operation is not preferable from the viewpoint of production efficiency, and thus it is preferable to directly subject the pulverized material obtained in the pulverizing step to the heating in the step (iii).

As the solvent that can be used in the step (iii), those described as the solvents that can be used in the step (i) can be used as solvent components other than the dispersant, and those having a boiling point higher than that of the complexing agent and solvent used in the complexing step are preferably used. Of these, it is preferable to use a solvent that is generally treated as a high boiling point solvent, such as a mixture of an aromatic hydrocarbon solvent and an aromatic ether solvent.

In the production method of the present embodiment, after the step (iii), it is preferable to perform solid-liquid separation such as decantation, and to remove the solvent including the dispersant in the same manner as the drying step described above. Conditions such as drying temperature and drying time in the drying step of the solvent are the same as those in the drying step described above.

### (Crystal Structure of Solid Electrolyte)

Examples of the solid electrolyte obtained by the production method of the present embodiment include an argyrodite type crystal structure, such as Li₆PS₅X and Li₇₋ₓPS₆₋ₓXₓ (X=Cl, Br, I, x=0.0 to 1.8) (JP 2011-096630 A, JP 2013-211171 A, etc.). Diffraction peaks of these argyrodite type crystal structures appear, for example, near 2θ=15.3°, 17.7°, 31.1°, 44.9°, and 47.7°.

Moreover, examples of an argyrodite type crystal structure also include the following.

The crystal structure represented by a compositional formula Li₇₋ₓP_{1-y}Si_{y}S₆ or Li₇₊ₓP_{1-y}Si_{y}S₆ (x is −0.6 to 0.6, and y is 0.1 to 0.6), which has the aforementioned structure skeleton of Li₇PS₆ and in which a part of P is substituted with Si, is a cubic crystal or a rhombic crystal, and is preferably a cubic crystal, and in X-ray diffractometry using a CuKα ray, the crystal structure gives peaks appearing mainly at 2θ=15.5°, 18.0°, 25.0°, 30.0°, 31.4°, 45.3°, 47.0°, and 52.0°.

The crystal structure represented by the aforementioned compositional formula Li_{7-x-2y}PS_{6-x-y}Clₓ (0.8≤x≤1.7, and 0≤y≤(−0.25x+0.5)) is preferably a cubic crystal, and in the X-ray diffractometry using a CuKα ray, the crystal structure gives peaks appearing mainly at 2θ=15.5°, 18.0°, 25.0°, 30.0°, 31.4°, 45.3°, 47.0°, and 52.0°.

The crystal structure represented by the aforementioned compositional formula Li₇₋ₓPS₆₋ₓHaₓ (Ha represents Cl or Br, and x is preferably 0.2 to 1.8) is preferably a cubic crystal, and in the X-ray diffractometry using a CuKα ray, the crystal structure gives peaks appearing mainly at 2θ=15.5°, 18.0°, 25.0°, 30.0°, 31.4°, 45.3°, 47.0°, and 52.0°.

These peak positions may vary within a range of ±0.5°.

The crystal structure of the solid electrolyte obtained by the production method of the present embodiment is preferably an argyrodite type crystal structure in that higher ionic conductivity can be obtained.

The solid electrolyte obtained by the production method of the present embodiment may have the argyrodite type crystal structure described above, or may have the argyrodite type crystal structure as a main crystal. However, from the viewpoint of obtaining higher ionic conductivity, it is preferable to have the argyrodite type crystal structure as a main crystal. In the present specification, “having as a main crystal” means that the ratio of the target crystal structure in the crystal structure is 80% or more, preferably 90% or more, and more preferably 95% or more.

In addition, the solid electrolyte obtained by the production method of the present embodiment preferably does not contain crystalline Li₃PS₄ (β-Li₃PS₄) from the viewpoint of obtaining higher ionic conductivity. Whether or not the solid electrolyte does not contain crystalline Li₃PS₄ (β-Li₃PS₄) can be determined by the presence or absence of diffraction peaks at 2θ=17.5° and 26.1° seen in crystalline Li₃PS₄. In the present specification, it is supposed that the solid electrolyte does not contain crystalline Li₃PS₄ (β-Li₃PS₄) as long as it does not have the diffraction peak or, even if it does, a very small peak compared to the diffraction peak of the argyrodite type crystal structure is detected.

The solid electrolyte obtained by the production method of the present embodiment preferably has an average particle size (D50) of 0.01 μm or more and 100 μm or less, more preferably 0.03 μm or more and 50 μm or less, even more preferably 0.05 μm or more and 10 μm or less, and still more preferably 0.1 μm or more and 3.0 μm or less, as measured by a laser diffraction scattering particle size distribution measurement method.

In addition, the solid electrolyte obtained by the production method of the present embodiment preferably has a particle size (D90) at 90% of the cumulative volume measured by a laser diffraction scattering particle size distribution measurement method of 0.10 μm or more and 20.0 μm or less. more preferably 0.40 μm or more and 15.0 μm or less, and still more preferably 0.60 μm or more and 9.0 μm or less.

### EXAMPLES

Next, the present invention will be described specifically with reference to Examples; however, it should be construed that the present invention is by no means restricted by these Examples.

### Example 1

Into a 6-liter reaction vessel equipped with a stirrer, lithium sulfide and diphosphorus pentasulfide were weighed and added in a molar ratio of 75:25 in a nitrogen atmosphere. After adding toluene, a stirring blade was operated and tetrahydrofuran (THF) was added dropwise at 20° C. After stirring for 72 hours, the reaction was terminated to obtain a 3THF addition complex of Li₃PS₄ having a PS₄³⁻ structure.

Subsequently, the 3THF adduct of Li₃PS₄ was dried under reduced pressure at 80° C. for 2 hours and then heat-treated at 180° C. for 6 hours to obtain crystalline Li₃PS₄ (β-Li₃PS₄) having a PS₄³⁻ structure. It was determined as crystalline Li₃PS₄ by the fact that diffraction peaks appeared at 17.5° and 25.7° as a result of powder X-ray diffraction measurement using an X-ray diffraction (XRD) device (SmartLab device, manufactured by Rigaku Corporation).

To the obtained crystalline Li₃PS₄ (β-Li₃PS₄), lithium sulfide (Li₂S), lithium chloride (LiCl), and lithium bromide (LiBr) were further weighed and added in ratios of 40, 100, and 60, respectively, based on the molar ratio of lithium sulfide and diphosphorus pentasulfide of 75:25. DowthermA solvent (manufactured by Dow, 30% by mass of biphenyl and 70% by mass of diphenyl ether) was added in an amount such that the total amount of these raw materials was 10% by mass, and sodium dodecylbenzenesulfonate (boiling point: 444° C.), which is a dispersant, was further added in an amount of 5% by mass with respect to the total amount of the above raw materials, and pulverization was performed for 2 hours using a bead mill (LABSTAR Mini LMZ015, manufactured by Ashizawa Finetech Ltd.) for 2 hours to obtain a slurry containing a pulverized material of an electrolyte precursor. Zirconia beads with a diameter of 0.3 mm were used in the pulverization treatment. As a result of measuring the particle size distribution of the electrolyte precursor after pulverization, the average particle size (D50) was 0.2 μm.

The slurry obtained as described above was sealed in an autoclave apparatus and heated at 395° C. for 30 minutes. At that time, the internal pressure of the autoclave was 0.90 MPa.

Thereafter, the solvent was removed using a cannula, and dehydrated toluene was further added and stirred. The solvent was removed by decantation, and further dried by heating at 180° C. for 2 hours to obtain a solid electrolyte having an argyrodite type crystal structure. The obtained solid electrolyte was determined to have an argyrodite type crystal structure by the fact that diffraction peaks appeared at 15.3°, 17.7°, 31.1°, 44.9°, and 47.7° as a result of powder X-ray diffraction measurement.

As a result of measuring the particle size distribution of the obtained solid electrolyte, the average particle size (D50) was 0.82 μm, and the particle size (D90) at 90% of the cumulative volume was 1.7 μm.

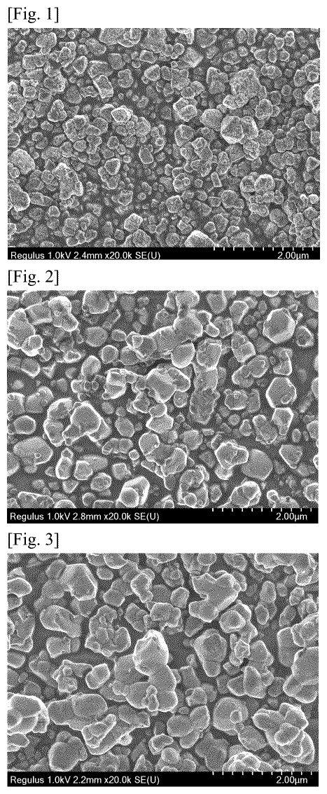

Furthermore, an SEM (scanning electron microscope) photograph of the solid electrolyte obtained in Example 1 is shown in FIG. 1.

### Example 2

A solid electrolyte was obtained in the same manner as in Example 1 except that to a mixture of the crystalline Li₃PS₄ (β-Li₃PS₄) obtained in the same manner as in Example 1 and Li₂S, LiCl, LiBr, and DowthermA solvent, an oleylamine (boiling point: 350° C.) was added as a dispersant in an amount of 10% by mass with respect to the total amount of raw materials.

As a result of measuring the particle size distribution of the obtained solid electrolyte, the average particle size (D50) was 1.4 μm, and the particle size (D90) at 90% of the cumulative volume was 3.6 μm.

Furthermore, an SEM (scanning electron microscope) photograph of the solid electrolyte obtained in Example 2 is shown in FIG. 2.

### Example 3

A solid electrolyte was obtained in the same manner as in Example 1 except that to a mixture of the crystalline Li₃PS₄ (β-Li₃PS₄) obtained in the same manner as in Example 1 and Li₂S, LiCl, LiBr, and DowthermA solvent, sodium dodecylbenzenesulfonate was added as a dispersant in an amount of 3% by mass with respect to the total amount of raw materials.

As a result of measuring the particle size distribution of the obtained solid electrolyte, the average particle size (D50) was 1.2 μm, and the particle size (D90) at 90% of the cumulative volume was 4.4 μm.

### Example 4

Lithium sulfide (Li₂S), diphosphorus pentasulfide (P₂S₅), lithium chloride (LiCl) and lithium bromide (LiBr) pre-pulverized in a pin mill (100UPZ, manufactured by Hosokawa Micron Corporation) were mixed in a molar ratio of 47.5:12.5:25.0:15.0, and the mixture was placed in a glass container and coarsely mixed by shaking the container. The resulting crude mixture was dispersed in a mixed solvent of dehydrated toluene (manufactured by Wako Pure Chemical Industries, Ltd.) and dehydrated isobutyronitrile (manufactured by Kishida Chemical Co., Ltd.) under a nitrogen atmosphere to form a slurry of about 10% by mass.

The resulting slurry was mixed and pulverized using a bead mill while being kept in the nitrogen atmosphere. Specifically, 456 g of zirconia beads with a diameter of 0.5 mm were used as grinding media, and the bead mill was operated under the conditions of a peripheral speed of 12 m/s and a flow rate of 500 ml/min. The slurry was charged into the mill and circulated for 1 hour. After the treated slurry was placed in a Schlenk bottle in which nitrogen was substituted, it was dried under reduced pressure to prepare a raw material mixture.

The raw material mixture obtained in the above step was dispersed in 300 ml of ethylbenzene (manufactured by Wako Pure Chemical Industries, Ltd.) to form a slurry. The slurry was put into an autoclave (capacity: 1000 ml, made of SUS316) equipped with a stirrer and a heating oil bath, and heat-treated at 200° C. for 2 hours while stirring at 200 rpm. After the treatment, the solvent was distilled off by drying under reduced pressure to obtain a treated product.

To the calcined product obtained in the above step, a DowthermA solvent was added in an amount such that the total amount was 10% by mass, and 5% by mass of sodium dodecylbenzenesulfonate was further added as a dispersant. The mixture was milled in the same manner as in Example 1, and the resulting slurry was directly heated at 395° C. for 30 minutes using an autoclave. Thereafter, the solvent was removed using a cannula and the work of heating and drying was performed in the same manner as in Example 1.

As a result of measuring the particle size distribution of the obtained solid electrolyte, the average particle size (D50) was 1.4 μm, and the particle size (D90) at 90% of the cumulative volume was 4.7 μm.

### Comparative Example 1

A solid electrolyte was obtained in the same manner as in Example 1 except that a dispersant was not added to a mixture of the crystalline Li₃PS₄ (β-Li₃PS₄) obtained in the same manner as in Example 1 and Li₂S, LiCl, LiBr, and DowthermA solvent.

As a result of measuring the particle size distribution of the obtained solid electrolyte, the average particle size (D50) was 4.3 μm, and the particle size (D90) at 90% of the cumulative volume was 7.6 μm.

Furthermore, an SEM (scanning electron microscope) photograph of the solid electrolyte obtained in Comparative Example 1 is shown in FIG. 3.

The average particle size (D50) and the particle size (D90) at 90% of the cumulative volume of each of the solid electrolytes obtained in Examples 1 to 4 and Comparative Example 1 are shown below.

TABLE 1

| | Average particle | Particle size at 90% of |
|---|---|---|
| | size (D50) | cumulative volume (D90) |
| | (μm) | (μm) |
| Example 1 | 0.82 | 1.7 |
| Example 2 | 1.4 | 3.6 |
| Example 3 | 1.2 | 4.4 |
| Example 4 | 1.4 | 4.7 |
| Comparative Example 1 | 4.3 | 7.6 |

### INDUSTRIAL APPLICABILITY

According to the method for producing a crystalline solid electrolyte of the present embodiment, a solid electrolyte having a small particle size and a high ionic conductivity can be produced, and it is particularly suitable for producing a solid electrolyte having an argyrodite type crystal structure.

In addition, the solid electrolyte obtained by the production method of the present embodiment is suitably used for batteries, especially batteries for information-related instruments, communication instruments, and so on, such as personal computers, video cameras and mobile phones.

1. A method for producing a sulfide solid electrolyte, comprising
mixing a raw material inclusion containing a lithium atom, a sulfur atom, a phosphorus atom, and a halogen atom to obtain an electrolyte precursor, and
heating the electrolyte precursor in the presence of a solvent containing a dispersant having a linear or branched hydrocarbon group having 8 or more carbon atoms in a sealed pressure resistant vessel.

2. The method for producing a sulfide solid electrolyte according to claim 1, wherein the dispersant has a boiling point of 170° C. or higher.

3. The method for producing a sulfide solid electrolyte according to claim 1, wherein the dispersant is one or more selected from an anionic dispersant having a linear or branched hydrocarbon group having 8 to 30 carbon atoms, a cationic dispersant having a linear or branched hydrocarbon group having 8 to 30 carbon atoms, and a nonionic dispersant having a linear or branched hydrocarbon group having 8 to 30 carbon atoms.

4. The method for producing a sulfide solid electrolyte according to claim 1, wherein the dispersant is a sulfonate.

5. The method for producing a sulfide solid electrolyte according to claim 1, wherein the temperature when heating the electrolyte precursor is 250° C. or higher and 500° C. or lower.

6. The method for producing a sulfide solid electrolyte according to claim 1, wherein, when heating the electrolyte precursor, the pressure resistant vessel has an internal pressure of 0.35 MPa or more and 2.0 MPa or less.

7. The method for producing a sulfide solid electrolyte according to claim 1, wherein the pressure resistant vessel is an autoclave apparatus.

8. The method for producing a sulfide solid electrolyte according to claim 1, wherein the raw material inclusion contains at least chlorine as the halogen atom.

9. The method for producing a sulfide solid electrolyte according to claim 1, wherein the solvent has a boiling point of 190° C. or higher.

10. The method for producing a sulfide solid electrolyte according to claim 1, wherein the solvent further contains one or more selected from an aromatic hydrocarbon solvent and an ether-based solvent.

11. The method for producing a sulfide solid electrolyte according to claim 1, wherein, when the heating is carried out, the dispersant has an amount of 0.1 to 20% by mass with respect to an amount of the electrolyte precursor.

12. The method for producing a sulfide solid electrolyte according to claim 1, wherein, when the heating is carried out, a ratio of an amount of the electrolyte precursor to a total amount of the electrolyte precursor and the solvent is 0.50 to 50% by mass.
